(19) United States
(12) Patent Application Publication
(10) Pub. No.: US 2023/0169218 A1
(43) Pub. Date: Jun. 1, 2023

(54) METHOD FOR DETERMINING A HOUSING FOR ELECTRONIC COMPONENTS

(71) Applicant: Phoenix Contact GmbH & Co. KG, Blomberg (DE)

(72) Inventors: Frank Best, Bueckeburg (DE); Fabio Weslau, Lemgo (DE)

(21) Appl. No.: 17/784,115

(22) PCT Filed: Dec. 10, 2020
(86) PCT No.: PCT/EP2020/085533

§ 371 Date: Jun. 10, 2022

(30) Foreign Application Priority Data
Dec. 13, 2019 (BE) 2019/5899

(51) Int. Cl. G06F 30/10

(52) U.S. Cl. CPC G06F 30/10; G06F 2119/08

(57) ABSTRACT

A method for determining a housing capable of accommodating waste heat generating electronic components on a printed circuit board includes: detecting an arrangement of the electronic components on a mounting side of the printed circuit board; determining several functional areas within the mounting side in which at least one of the electronic components is arranged according to the detected arrangement; assigning a thermal function to each of the functional areas, each of the thermal functions comprising: a function for generating waste heat due to a power dissipation of the at least one electronic component arranged in a respective functional area according to the detected arrangement during operation, and a maximum temperature up to which the at least one electronic component arranged in the respective functional area is operable without damage and performance limitation.

### CROSS-REFERENCE TO PRIOR APPLICATIONS

This application is a U.S. National Phase application under 35 U.S.C. § 371 of International Application No. PCT/EP2020/085533, filed on Dec. 10, 2020, and claims benefit to Belgian Patent Application No. BE 2019/5899, filed on Dec. 13, 2019. The International Application was published in German on June 17, 2021 as WO/2021/116287 under PCT Article 21(2).

### FIELD

The invention relates to a method of determining a housing configured to accommodate electronic components that dissipate heat (also: waste heat) on a printed circuit board.

### BACKGROUND

Nowadays, numerically supported product development includes also virtual product development, especially for the application product development with regard to the use cases or field of application of the product and its project planning. Often these development processes are not the core expertise of a developer or designer. For example, the developer of a circuit may know the use of the circuit but develops it with automated development tools as an example of numerical support. Details such as thermal requirements or implications of the circuits are often not the subject of her or his work.

### SUMMARY

In an embodiment, the present invention provides a method for determining a housing capable of accommodating waste heat generating electronic components on a printed circuit board, comprising: detecting an arrangement of the electronic components on a mounting side of the printed circuit board; determining several functional areas within the mounting side in which at least one of the electronic components is arranged according to the detected arrangement; assigning a thermal function to each of the functional areas, each of the thermal functions comprising: a function for generating waste heat due to a power dissipation of the at least one electronic component arranged in a respective functional area according to the detected arrangement during operation, and a maximum temperature up to which the at least one electronic component arranged in the respective functional area is operable without damage and performance limitation; and determining a housing which, according to the thermal functions assigned to the functional areas, is configured to dissipate the waste heat generated during operation of the electronic components while maintaining the maximum temperatures and/or determining whether a selected housing, according to the thermal functions assigned to the functional areas, is configured to dissipate the waste heat generated during operation of the electronic components while maintaining the maximum temperatures.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a flowchart of a method for determining a housing capable of accommodating waste heat generating electronic components on a printed circuit board, according to a first exemplary embodiment;

FIG. 2 shows schematic representations of each of the steps of the method for determining a housing according to a second exemplary embodiment.

FIG. 3 shows a schematic representation of a device for carrying out or controlling the method for determining a housing according to a third exemplary embodiment; and

FIG. 4 shows a schematic representation of an exemplary database that can be used in any of the exemplary embodiments.

### DETAILED DESCRIPTION

In an embodiment, the present invention provides a technique that supports such a developer in the product development.

Exemplary embodiments of the invention are described here below with partial reference to the figures.

One aspect is related to a method of determining a housing that can accommodate (or is configured to accommodate) waste heat generating electronic components on a printed circuit board. The method comprises a step of detecting an arrangement of the electronic components on a mounting side of the printed circuit board. The method further comprises a step of determining several functional areas within the mounting side, each of them having at least one of the electronic components mounted therein according to the detected arrangement. The method further comprises a step of assigning a thermal function (or thermal feature) to each of the functional areas. Each of the thermal functions (or thermal features) comprises a function (or feature) for generating waste heat due to power dissipation of the at least one electronic component arranged according to the detected arrangement in the respective functional area during operation. Furthermore, each of the thermal functions (or thermal features) comprises a maximum temperature up to which the at least one electronic component arranged in the respective functional area is in operation without damage and performance limitation. The method further comprises a step of determining a housing that is capable of dissipating the waste heat generated during the operation of the electronic components while maintaining the maximum temperatures according to the thermal functions assigned to the functional areas. Alternatively or additionally, the method comprises a step of determining whether a selected housing is capable of dissipating the waste heat generated during the operation of the electronic components while maintaining the maximum temperatures according to the thermal functions assigned to the functional areas.

Exemplary embodiments of the method can numerically analyse or verify a circuit under development with respect to its thermal requirements or implications by determining the functional areas and reducing them to their thermal function by detecting the arrangement of the components. In this way, a housing can be determined that not only fits the printed circuit board geometrically, but also thermally, i.e. a housing that fulfils the conditions specified by the thermal functions.

The assigned thermal function can be respectively equivalent to a thermal effect and/or a thermally conditioned operability of the at least one electronic component arranged according to the detected arrangement in the respective functional area in operation, for example when the associated thermal function is (preferably substantially) representative or characteristic of a thermal effect of the at least one electronic component arranged in the respective functional area, for example in a predetermined value range of the temperature of the printed circuit board or of the electronic components. The thermal function can represent the thermal effect and/or the thermally conditioned functionality of the at least one electronic component arranged in the respective functional area in a stationary (or quasi-stationary) state (for example, in a stationary operation and/or a thermodynamically stationary state) of the combination of printed circuit board and housing.

A numerical check (or assessment) of compliance with the maximum temperatures by dissipating the waste heat generated by the electronic components during operation according to the thermal functions assigned to the functional areas can realise a thermal stress test, i.e., a test for suitability of the (optionally manually selected) housing or a corresponding combination of housing and printed circuit board.

The determining of the housing may be performed subject to the requirement that the housing limits the power dissipation (also: heat load) of the electronic components, which arises during operation, to a permissible and/or non-damaging extent and/or not impairing the performance and/or functionality of the electronic component. The specific housing is configured, based on stored or calculated values (for example the temperature distribution), to limit the thermal load (for example a temperature) of the at least one component in the respective functional area (for example power losses and/or temperature distribution in the housing) arising on the printed circuit board during the operation of all components below a limit value affecting the component (for example lower than the respective maximum temperature).

The maximum temperature may be an upper limit value to an operating temperature of the electronic component. Up to the maximum temperature, the electronic component can be functional without damage and performance limitation.

The power loss during operation may be a rate of the waste heat generated in the respective functional area.

Alternatively or additionally, the dissipation of the waste heat may comprise a heat transport, for example a passive heat transport and/or an active heat transport of the waste heat. The dissipation of the waste heat may comprise a heat transfer of the waste heat out of the housing to an environment of the housing.

The operation of the electronic components may be a regular operation or a limiting operation (for example for a thermal stress test) of the electronic components.

The functional areas can be elementary cells of a grid structure or tiles of a tiling of the mounting side of the printed circuit board. Alternatively or additionally, the at least two functional areas can be a partitioning of the mounting side of the printed circuit board.

The thermal functions can be thermally primitives (in short: primitives) of a thermal model (for example, a thermodynamic model). The totality of the assigned thermal functions, in combination with the respective housing, can define a thermal model on which the step of determining the housing is based. Optionally, the housing is represented by its own thermal function in the thermal model.

In the step of determining a housing, a single housing or a plurality of housings can be determined, preferably each of them capable of dissipating from the electronic components the waste heat generated during operation without overheating the respective housing and/or the electronic components.

The thermal functions can depend on an operating state of the electronic components. The operation of the electronic components can comprise a first operating state and a second operating state that is different from the first operating state. A first power dissipation can be greater in a first functional area in the first operating state than in the second operating state. A second power dissipation can be smaller in a second functional area in the first operating state than in the second operating state.

The housing can be determined for time-dependent operating states. The second operating state can correspond to a thermal stress test and/or be present for a predetermined period of time or be limited to the predetermined period of time.

The thermal function can further comprise, in at least one of the functional areas of the printed circuit board or in a further functional area of the housing, a function of a heat transport according to the at least one electronic component arranged in the respective functional area and/or according to a heat sink or ventilation openings (for example ventilation and/or exhaust openings) in the respective functional area or in the further functional area.

The heat transport function can represent a passive heat transport (for example heat conduction and/or convection, preferably in a heat pipe, and/or heat radiation). Alternatively or additionally, the heat transport function can represent an active heat transport (for example, by means of an electro-thermal converter and/or a heat pump). The heat transport can take place inside the housing, for example in parallel to the printed circuit board. Alternatively or additionally, the heat transport can take place out of the housing to an environment of the housing, preferably to an exterior of the housing or a heat sink in heat exchange with the environment.

One or each of the thermal functions can comprise the function of a heat source in the respective functional area and/or the function of a heat sink in the respective functional area and/or the function of a heat transport in the respective functional area. Preferably, the heat transport function corresponds to or represents the function of a thermal bridge or a thermal insulation between the respective functional area and an environment of the housing.

Optionally, the “heat source” includes a negative heat source, i.e. a heat sink. For example, the disclosure of a heat source can be realised by a heat sink. Similarly, “waste heat” can include negative “waste heat”. For example, the generation of waste heat can be realised by a dissipation of heat (for example out of the housing) or a conversion of heat into another form of energy (for example light or electric current by means of the Seebeck effect).

Furthermore, a thermal function, for example the thermal function of an interface of a heat convection, can be assigned to the respective housing and/or the printed circuit board.

The function of the heat sink can correspond to a Peltier element whose warm side is in heat exchange with the environment and whose cold side is arranged in the housing in the respective functional area. The function of the heat source can correspond to a Peltier element whose cold side is in heat exchange with the environment and whose warm side is arranged in the housing in the respective functional area.

The thermal function of the heat transport can include a thermal conduction, a thermal radiation and/or a thermal convection.

The thermal function of the heat transport can comprise a passive heat transport. For example, the thermal function of the heat transport can be equivalent to or numerically represent the thermal function of a heat pipe. The heat pipe can also be technically referred to as “heat pipe”.

The thermal function of the heat transport can include an active heat transport. For example, the thermal function of the heat transport can be equivalent to or numerically represent the thermal effect of a Peltier element. During operation, the Peltier element can have a warm side and a cold side. The Peltier element can additionally emit heat on the warm side which exceeds the heat transported from the cold side to the warm side.

A Peltier element whose warm side is in heat exchange with the environment and whose cold side is arranged in the housing in the respective functional area, can correspond to the function of a heat sink. A Peltier element, whose cold side is in heat exchange with the environment and whose warm side is arranged in the housing in the respective functional area, can correspond to the function of a heat source.

The determining of a housing can comprise determining a plurality of housings, each of them preferably capable of dissipating the waste heat generated during the operation of the electronic components while maintaining the maximum temperatures, according to the thermal functions assigned to the functional areas.

Furthermore, the smallest housing in terms of space requirement or width can be determined among the plurality of housings. Herein, a size comparison (“smallest”) can refer to the volume and/or a cross-section and/or a linear dimension of the housing, for example, the housing with the smallest space requirement and/or the smallest width in the direction of an apposition on a mounting rail (for example, a holding rail or a top-hat rail), i.e. in the longitudinal direction of the mounting rail or holding rail.

Each housing of the plurality of housings can in each case be configured for mounting on a mounting rail (preferably on a top-hat rail). The determined smallest housing can be the narrowest housing among the plurality of housings in a longitudinal direction of the mounting rail.

Determining the housing can comprise calculating or querying a temperature or a temperature distribution in the plurality of housings according to the thermal functions associated with the functional areas. Optionally, it is possible to determine the housing whose temperature or temperature distribution is within a predetermined range of values and/or whose temperature is the smallest among the plurality of housings.

The housings can include a housing specified by a user, for example a housing that is manually selected from a database. The plurality of housings can include housing variants selected by the user, for example housings that match the predetermined housing with respect to at least one parameter stored in the database and/or are similar to the predetermined housing with respect to parameters stored in the database. Hereby, the similarity can be determined on the basis of a metric of a parameter space spanned by the parameters. Two housings can be similar to each other if the value of the metric for the two housings is less than a limit value.

The calculation of the temperature distribution can include calculating a distribution (or a profile) of a temperature gradient, for example over housing surfaces of the housing and/or a volume enclosed or surrounded by the housing.

The calculation of the temperature or the temperature distribution can comprise a numerical simulation of a thermodynamic process (also: thermodynamic simulation), preferably of a heat transport, within the respective housing and/or out of the respective housing, wherein the combination of the respective housing with the thermal functions assigned to the functional areas of the printed circuit board determines boundary conditions of the thermodynamic process.

The numerical simulation of the thermodynamic process can be a numerical simulation of the housing and printed circuit board model, where the printed circuit board is represented by the thermal functions associated with the functional areas and the housing is represented by its own thermal function. The numerical simulation of the thermodynamic process can be an implementation of the thermal stress test, i.e., the thermal suitability test of the combination of housing and printed circuit board.

The thermodynamic process within the respective housing and/or out of the respective housing comprises a convection and/or flow of a cooling medium, preferably air, into the respective housing, within the respective housing and/or out of the respective housing.

The determining of the housing can comprise querying a database. The following can be stored in the database for a plurality of housings: (i) boundary conditions, preferably boundary conditions of the simulation and/or boundary conditions of the thermodynamic process and/or boundary conditions of the manufacturing of the housing; and/or (ii) rules of a cross-linking of the housing; and/or (iii) materials of the housing; and/or (iv) temperatures and/or temperature distributions, for example depending on an arrangement of the thermal functions within the respective housing. The query (for example, a query message sent to the database) can indicate or determine the arrangement of the thermal functions assigned to the functional areas with the printed circuit board accommodated in the respective housing.

In the database, a temperature distribution (also: heat profile or thermal profile) can be stored for a plurality of combinations of a housing and an arrangement of thermal functions, respectively. Based on the database query, a simulation does not have to be executed several times, for example if an arrangement of thermal functions corresponding to the printed circuit board is already stored in the database. The arrangement of the thermal functions can be an abstraction of the printed circuit board for the purpose of calculating or querying, respectively, the temperature distribution and/or for the purpose of determining the housing, the thermal model and/or the thermodynamic simulation. The temperature distributions stored in the database for combinations of housing and arrangement of thermal functions can be empirically determined and/or the results of previous numerical simulations.

For example, the numerical simulation for a detected arrangement of thermal functions is only executed if no temperature distribution for the detected arrangement is stored in the database. For each executed numerical simulation, the temperature distribution database can be complemented or specified as a property of the respective housing.

Alternatively or additionally, the temperature distribution for each of the plurality of housings can be stored in the database in a flexible and/or adaptable manner for different arrangements of the thermal functions. For example, for a detected thermal function arrangement, which is among two or more thermal function arrangements stored in the database, the temperature distribution for the detected thermal function arrangements can be calculated as a weighted average of the temperature distributions with respect to the stored thermal function arrangements.

The database can store the temperatures and/or temperature distributions resulting from previous numerical simulations. A temperature and/or temperature distribution stored in the database for a similar or the most similar arrangement of the associated thermal functions can be a starting value for the numerical simulation of the thermodynamic process.

The query of the database can result in an initial housing. The temperature distribution stored or calculated for the initial housing cannot comply with the maximum temperature at one point, for example in a functional area in the initial housing. The method (for example, the determining of the housing) can further comprise a step of modifying the housing at the location where the temperature distribution does not comply with the maximum temperature. Alternatively or additionally, the method (for example, the determining of the housing) can further comprise a step of calculating the temperature distribution in the modified initial housing according to the thermal functions assigned to the functional areas.

The determining of the housing, starting from the initial housing, can perform in iterative manner the steps of modifying and calculating until the maximum temperatures are met.

The initial housing can be a housing specified by a user. The determining of the housing can comprise an adjustment (i.e. modifying) of the initial housing and/or selecting a different (preferably larger) housing (for example from a database).

The determining of the housing, starting from the initial housing, can comprise a multi-step execution of the steps of modifying and calculating. In a first step of the multi-step performance, the housing can be modified in a first area. In a second step, starting from the modification in the first step, the housing can be modified in a second area. It is smaller than the first area and lies completely within the first area. In other words, the multi-step modification can include a rough first modification and a refined second modification of the housing based on the first modification.

Alternatively or additionally, the modifying of the housing can include supplementing thermal bridges between the location and an exterior area of the housing and/or supplementing ventilation openings, preferably at the location.

The housing can be represented by its own thermal function. The thermal function of the housing can determine a geometric shape of the housing, for example a cuboid. Surfaces and/or partial surfaces of the housing can be assigned a temperature distribution and/or a flow profile of the cooling medium. Alternatively or additionally, surfaces and/or partial surfaces of the housing can determine the boundary conditions of a thermodynamic process, for example boundary conditions of a convection of the cooling medium. In the step of modifying the housing, a modified thermal function (preferably with a modified temperature distribution and/or a modified flow profile) can be loaded from the database as a representative of the modified housing.

The modifying of the housing can comprise a thermal conductivity change of the housing at least at the location. Preferably, the changed thermal conductivity can correspond to a changed wall thickness and/or a changed wall material of the housing.

The modifying of the housing can be subject to at least one constraint, for example minimum internal dimensions of the housing to accommodate the printed circuit board, predetermined fixing points in the housing to fix the printed circuit board, predetermined attachment points to mount the housing to a mounting rail, boundary conditions of a manufacturing of the housing and/or maximum external dimensions of the housing.

The respective housing, preferably a geometry or the surfaces of the respective housing, can be numerically represented by a Delaunay triangulation, a hierarchical data structure, an octree mesh or a hexahedral mesh, preferably as part of the thermal function of the housing.

Each of the functional areas can be within the mounting side of the printed circuit board rectangular areas and/or disjoint partial areas of the mounting side.

At least one or each of the assigned thermal functions, preferably heat sources, can be numerically represented by a crossing-free conductor track section whose path length within the respective functional area is greater than an extent of the respective functional area. Each conductor track section can be an ohmic conductor and/or meander-shaped.

An ohmic resistance of the conductor track section, a current intensity through the conductor track section and/or a power dissipation of the conductor track section can each be equivalent to an ohmic resistance, a current intensity or a power dissipation, respectively, of the at least one electronic component in operation arranged in the respective functional area according to the detected arrangement.

Detecting the arrangement of the electronic components can further comprise detecting an interconnection of the electronic components.

The assignment of thermal functions can further comprise a numerical simulation (preferably an electrodynamic simulation) of the electronic components detected according to the interconnection. The numerical simulation can determine the thermal function of the at least one electronic component in the respective functional area during operation. The numerical simulation of the detected electronic components according to the interconnection can include determining a power consumption of each of the electronic components in operation.

The determining of the housing, preferably the numerical simulation according to the interconnection, can further comprise determining clearances and/or leakage distances, preferably as a function of a nominal voltage of the printed circuit board.

The step of detecting the arrangement of the electronic components can comprise obtaining a camera image of the printed circuit board by means of a camera or by scanning the printed circuit board with a scanner. Alternatively or additionally, the step of detecting the arrangement of the electronic components can comprise the determining of electronic components and/or conductor tracks in the camera image or the scan by means of image recognition and determining the arrangement of the electronic components and/or the interconnection on the printed circuit board based on positions of the detected electronic components in the camera image or the scan of the printed circuit board and/or a course of the detected conductor tracks in the camera image or the scan of the printed circuit board. The printed circuit board can be a real component.

Alternatively or additionally, the detection of the arrangement of the components can comprise a receiving of a digital design drawing of the printed circuit board. Alternatively or additionally, the detection of the arrangement of the components can comprise reading out the arrangement of the electronic components and/or the interconnection of the electronic components from the digital design drawing of the printed circuit board. The electronic components can be substituted in the step of assigning by numerical representatives, preferably the assigned thermal functions.

The digital design drawing of the printed circuit board can be a numerical representation of a computer-aided design (CAD) or CAD model.

Optionally, the initial housing can also be obtained, for example uploaded, for iterative modification.

The method can further comprise providing a web page for retrieval. The web page can comprise an input area or an interface configured to create and/or upload the digital design drawing. The input area of the web page can be implemented as a web interface or web application (also: Web app).

The method can further comprise at least one of the following steps: Selecting the housing determined to be capable of dissipating the waste heat generated during the operation of the electronic components (preferably after the determination); selecting the housing, for which it has to be determined whether it is capable of dissipating the waste heat generated during operation of the electronic components (preferably before the determination); determining and/or providing the printed circuit board based on the selected housing (preferably after the selection).

The arrangement of the electronic components on the printed circuit board can also be referred to as the layout or the circuit of the printed circuit board. The electronic components on the printed circuit board can also be referred to as real components.

According to a further aspect, a device for determining a housing capable of accommodating the waste heat generating electronic components on a printed circuit board. The device comprises an arrangement detection unit configured to detect an arrangement of the electronic components on a mounting side of the printed circuit board. Further, the device comprises an area determination unit configured to determine several functional areas within the mounting side in which at least one of the electronic components is arranged according to the detected arrangement. Further, the device comprises a thermal function assignment unit configured to assign a thermal function to each of the functional areas. Each of the thermal functions comprises a function for generating waste heat based on a power dissipation of the at least one electronic component arranged according to the detected arrangement in the respective functional area during operation. Furthermore, each of the thermal functions comprises a maximum temperature up to which the at least one electronic component arranged in the respective functional area is in operation without damage and performance limitation. Furthermore, the device comprises a housing determination unit configured to determine a housing which, according to the thermal functions assigned to the functional areas, is capable of dissipating the waste heat generated during operation of the electronic components while maintaining the maximum temperatures.

The device can further comprise any of the features mentioned in the context of the method. Further, the device can be configured for this purpose or comprise dedicated units configured to perform any of the steps disclosed in the context of the method.

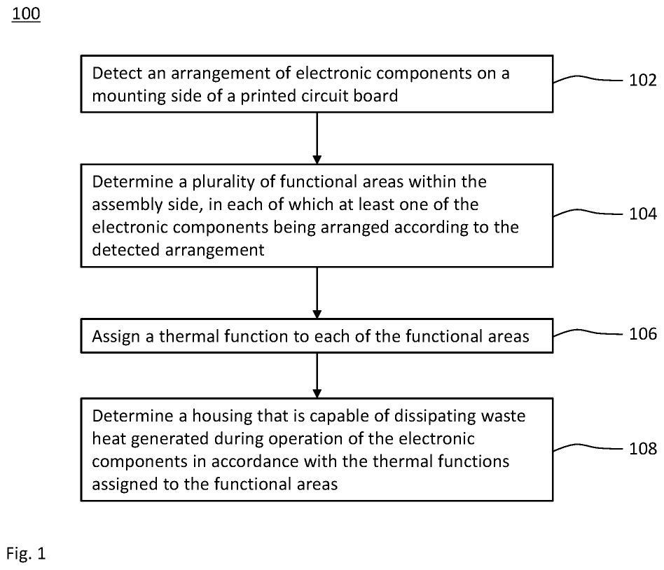

FIG. 1 shows a schematic flowchart of a first exemplary embodiment of a method, generally designated by reference numeral 100, for determining a housing capable of accommodating waste heat generating electronic components on a printed circuit board. In step 102, an arrangement of the electronic components on a mounting side of the printed circuit board is detected. In a step 104, several functional areas within the mounting side are determined. For this purpose, the electronic components can be grouped according to their functional relationship (for example, transistors of an H-bridge or impedances of a resistor-capacitor circuit or RC element) and/or according to their electrical connection density (for example, on the basis of also detected conductor tracks) and/or on the basis of a cluster analysis of the positions in the mounting side. Preferably, at least one of the electronic components is arranged in each functional area according to the detected arrangement. Optionally, further functional areas can be determined for thermally relevant functions, for example heat sinks.

At least one thermal function is assigned to each of the functional areas in a step 106. The thermal function can be a numerical representation of the thermal effect of the respective functional area. The thermodynamic simulation can include these thermal functions.

An example of the thermal function is a function for generating waste heat based on a power loss of the at least one electronic component in operation arranged in the respective functional area according to the detected arrangement. This function can, for example, indicate an average power loss or a correlation between power losses in different functional areas. An example of the thermal function is further a maximum temperature up to which the at least one electronic component arranged in the respective functional area is in operation without damage and limitation of performance.

In a step 108, at least one housing is determined which, according to the thermal functions assigned to the functional areas, is capable of dissipating the waste heat generated during operation of the electronic components while maintaining the maximum temperatures. The compliance is preferably determined by means of a thermodynamic state (TDZ) in the respective housing when the components on the printed circuit board arranged in the housing are in (preferably stationary) operation. The TDZ can be calculated numerically via a thermodynamic simulation and/or retrieved from a database.

The arrangement of the electronic components and the conductor tracks (for example, on the mounting side and/or an opposite side and/or a layer within the printed circuit board) which electrically connect the electronic components can be collectively referred to as circuit or layout of the printed circuit board.

The thermodynamic functions can be primitives of a design of the circuit and/or primitives of the thermodynamic simulation.

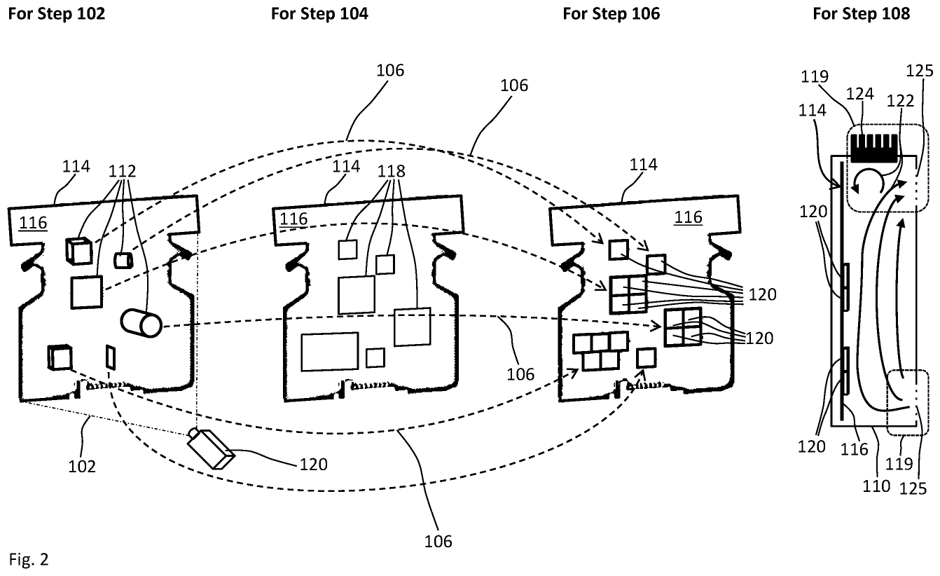

FIG. 2 shows schematic representations of each of the steps 102, 104, 106 and 108 of the method 100 for determining a housing 110 according to a second exemplary embodiment. The second exemplary embodiment can be combined with the first exemplary embodiment, for example complementing them.

The components 112 on the mounting side 116 of the printed circuit board 114 can be obtained from a digital design drawing, by manual entry, and/or by image recognition in step 102.

The printed circuit board 114, for example the entire mounting side 116 or the mounted parts of the mounting side 116, are divided into functional areas 118 in step 104. Preferably, the functional areas 118 comprise disjoint and/or limited partial surfaces of the mounting side 116.

An influence of the electronic components 112 (and optionally of the printed circuit board 114 itself) on the TDZ is numerically represented by means of thermal functions 120, which are assigned to the functional areas 118 in step 106. Optionally, another thermal function 120 is assigned to the printed circuit board 114 or the mounting side 116.

Each of the thermal functions can specify a thermodynamic effect (for example, a heat source, a heat sink and/or a heat transport) and/or at least one limit value (for example, a maximum temperature). The thermodynamic effect and/or the limit value can relate to the at least one component 112 in the functional area. For example, a type designation of the components 112 can be detected in step 102, and the thermodynamic effect and/or the at least one limit value can be retrieved from a database by specifying the type designation.

In step 108, a TDZ 122 is determined for each of at least two candidates for the housings 110, which result by the thermal functions 120 assigned by the functional areas 118 resulting from the laws of thermodynamics. For example, in step 108, a temperature distribution and/or a convection flow in the housing 110 and/or into the housing 110 and/or out of the housing 110 is calculated according to the laws of thermodynamics, preferably according to Planck's radiation law and/or the heat conduction equation and/or the Navier-Stokes equation. Further functional areas 119 can be determined thereby by the housing 110. For example, the further functional areas 119 can be associated with a ventilation opening 125 and/or an exhaust opening 125 and/or a heat sink 124 (preferably in heat exchange with an environment of the housing) as a thermal function.

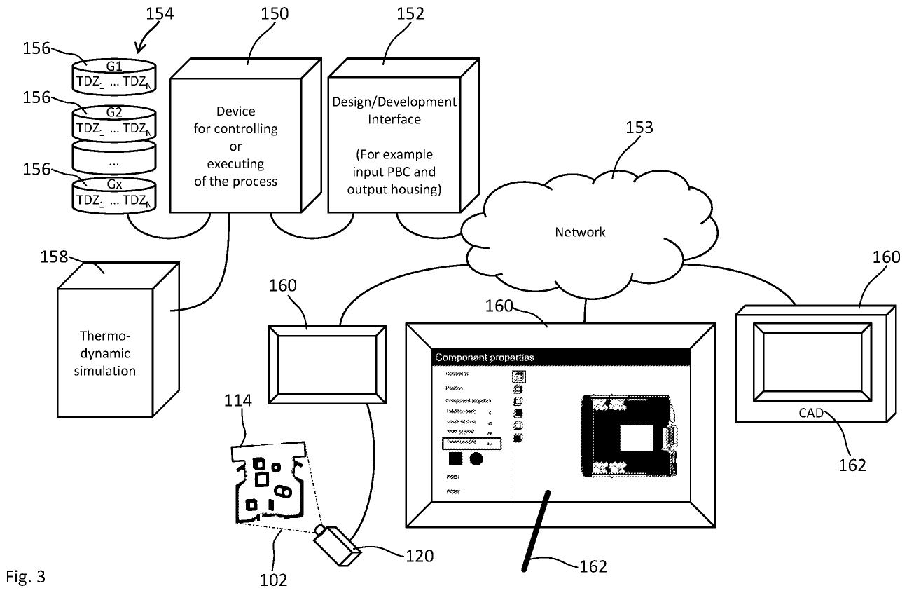

FIG. 3 shows a device, generally designated by reference numeral 150, for defining a housing 110 capable of receiving waste heat generating electronic components 112 on a printed circuit board 114. The device 150 can be configured to execute or control the process 100.

Alternatively or additionally, the device 150 can comprise an arrangement detection unit adapted to detect a layout of the electronic components 112 on a mounting side 116 of the printed circuit board 114 or to perform the step 102. The arrangement detection unit can be implemented by a design interface 152 configured to determine the arrangement of the components 112 (and optionally their interconnection).

The design interface 152 can be further configured to output, for example graphically display, the at least one particular housing 110.

The design interface 152 can be implemented by means of a web server that makes possible the arrangement of the components 112 on a web page in step 102 and/or outputs the particular housing 110 on the web page in step 108. The web page or other communication interface for steps 102 and/or 108 can be retrieved via a network 153. The network 153 can include network components such as network switches and/or base stations for radio access to the design interface 152.

The arrangement of the electronic components 112 can be detected by means of a user device 160, such as a mobile device (preferably a tablet computer with a touch-sensitive screen) or a workstation device (preferably a CAD workstation). For example, a camera 120 can be connected to the user device 160 or integrated into the user device 160. The camera 120 can capture a view of the mounting side (and optionally the conductor tracks on the opposite side). An image recognition unit (for example implementable in the user device 160 and/or the design interface 152 and/or the device 150) can determine objects on the printed circuit board in step 102. The specific objects can comprise the components 112 and optionally conductor tracks.

Alternatively or additionally, the user device 160 can comprise design means 162 for designing the arrangement of the components 112 and/or for inputting the arrangement of the components 112. The design means 162 can comprise a stylus for a touch-sensitive screen and/or a CAD application. The CAD application can be executed (for example, locally) by the user device 160 or executed (for example, remotely) by the design interface 152, wherein data from a graphical user interface section is transmitted from the design interface 152 to the user device 160 and displayed there.

For example, the detection step 102 can include the direct input of the primitives 120 (for example, data for selecting the primitives 120) and/or a determination of specific components 112. Alternatively or additionally, the detection step 102 can comprise uploading (i.e. upload) data showing the arrangement of the components 112 on the printed circuit board 114 (for example, data of the circuit layout).

Alternatively or additionally, the device 150 can comprise an area determination unit configured to determine the several functional areas 118 within the mounting side 116, in which at least one of the electronic components 112 is arranged according to the detected arrangement, or to perform step 104. Further, the device 150 comprises a thermal function assignment unit configured to assign at least one thermal function 120 to each of the functional areas 118 or to perform the step 106. The thermal function 120 can be a function for generating waste heat based on a power dissipation of the at least one electronic component arranged in the respective functional area according to the detected arrangement during operation. Alternatively or additionally, the thermal function 120 can indicate a maximum temperature up to which the at least one electronic component 112 arranged in the respective functional area 118 is in operation without damage and performance limitation.

Further, the device 150 comprises a housing determination unit configured to perform step 108 or to determine a housing 110 that is capable of dissipating the waste heat generated during the operation of the electronic components while maintaining the maximum temperatures according to the thermal functions assigned to the functional areas. To this purpose, the housing determination unit can determine a thermodynamic state (TDZ) based on the thermal functions 120 and the respective housing 110 (for example, a candidate for the determined housing 110). Further, the housing determination unit can determine whether the TDZ complies with (i.e. meets) the maximum temperature or temperatures according to the thermal functions 120.

If the maximum temperature or maximum temperatures (or further conditions of the functions 120) are met, the corresponding housing is outputted as the determined housing 110 from the device 150, for example for graphical display on the user device 160. For example (preferably in response to a confirmation of the determined housing 110 entered by means of the user device 160), the device 150 can send a digital order to ship the determined housing 110 to a warehouse.

The housing determination unit can calculate the TDZ by using a thermodynamic simulation 158 (technically also referred to as a simulation unit or “engine” for the thermal simulation) and/or retrieve it from a database 154. The database 154 preferably stores datasets 156 relating to a plurality of housings 110. Each housing dataset 156 indicates different TDZs depending on the arrangement of the thermal functions 120 within the housing 110, i.e. corresponding to the arrangement of the functional areas 118 (to which the thermal functions 120 are assigned) on the mounting side 116 of the printed circuit board 114 when the printed circuit board 114 is accommodated within the housing 110.

The arrangement of the electronic components 112 (i.e. the layout of the printed circuit board 114) or the arrangement of the corresponding thermal functions 120 can be tested, adjusted and/or optimised by means of the thermodynamic simulation 158. For example, in step 106, in a numerical representation of the printed circuit board 114 (for example, the arrangement of the components 112), the components 112 are replaced by or converted to the thermal functions 120. The thermal functions 120 can be primitives of the thermodynamic simulation 158. This allows a better performance of the simulation 158 to be achieved.

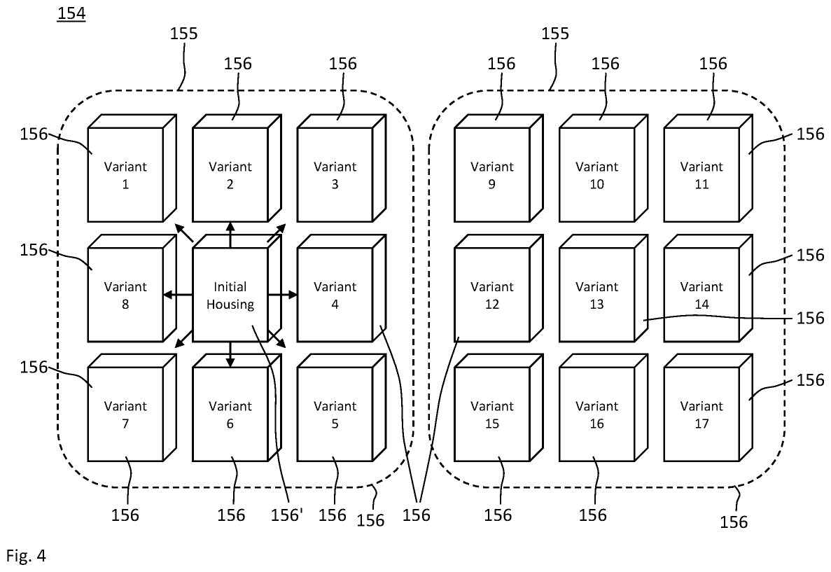

FIG. 4 shows schematically a structure of the database 154. The database 154 can store datasets 156 for a plurality of housings 110. Each dataset 156 related to a particular housing 110 can comprise a plurality of TDZs 122, respectively, depending on the arrangement of the thermal functions.

Preferably, an initial housing is determined based on the dimensions of the printed circuit board 114 and/or an input by means of the user device 160. A TDZ can be read out from its dataset 156′. Thereupon, the method 100 can perform an investigation in various directions and modify (i.e. alter) the housing 110 starting from the initial housing, for example to optimise a hardware setting. A metric indicates the similarity of two housings 110. By using the metric, the datasets 156 can be assigned to clusters 155. The modification can be done starting from the initial housing (i.e. the corresponding dataset 156′) within the respective cluster. For example, if a condition determined by the functions 120 (for example, the maximum temperature) is not met, the housing 110 is iteratively modified, wherein a (dataset 156 preferably adjacent to the dataset 156′ according to the metric of the dataset 156) is the basis for determining the TDZ 122. This modification is shown schematically by one of the arrows in FIG. 4.

After matching the thermal load, i.e. if the TDZ 122 retrieved by the thermal functions 120 for the modified housing 110 from the database 154 or calculated by the thermodynamic simulation 158 meets the conditions (such as the maximum temperature) determined by the thermal functions 120, the modified housing 110 can be outputted as the determined housing 110, for example via the network 153 and/or at the user device 160. Optionally, several housings 110 can be determined, one of which can be selected by means of the user device 160. For this purpose, it is possible to indicate, for example, which thermal reserve the determined housings have in each case, e.g. how large the difference is between the temperature according to the TDZ and the maximum temperature. For example, the housings 110 within a cluster 155 can have the same form factor and different bulges and/or heat sinks 124 and/or ventilation openings and/or exhaust openings 125.

In other words, exemplary embodiments of the method 100 can, on the one hand, numerically test a suitability combination of printed circuit board 114 (more specifically, the arrangement of the components 122) and of the housing 110 under thermal or thermodynamic criteria (for example, a maximum temperature) and then output the determined housing 110 as a recommendation.

Alternatively or additionally, an initial housing can be determined by means of the user device 160 and/or the design interface 152, and the method 100 modifies the initial housing, i.e. an automatic adaptation (for example, a housing exchange) or an adaptation of a layout of the housing 110 and/or the printed circuit board 114 is performed.

The modification of the housing 110 (and optionally the printed circuit board 114) can be performed iteratively or in multi-step manner in step 108. Preferably, the thermodynamic simulation 158 and the database 154 are used in combination, for example by retrieving the starting housing from the database, modifying it numerically and storing it as a new dataset 156 in the database 154. As a result, any future inquiries via the design interface 152 and/or the network 153 can be answered more quickly by the device 100.

In each dataset 156 and/or for thermodynamic simulation 158, the respective housing 110 can be numerically represented by at least one thermal function, for example as boundary conditions of the convection flow 122. Preferably, the thermal function of the housing comprises primitives, for example side faces, corner elements, fastening elements and/or ventilation openings and exhaust openings.

The collection 102 can comprise an input from a user at the user device 160 and/or via the design interface 152 by using an editor. The editor can be a CAD application. Alternatively or additionally, the collection 102 can comprise uploading (i.e. uploading via the network 153) a camera image or (preferably non-contact) scanning (i.e. a scan) of the real printed circuit board 114 (for example, the real mounting side 116) or the real arrangement (for example, the layout) of the components 112 of the printed circuit board 114. Alternatively or additionally, simplified representations of the arrangement of the components 112 can be uploaded or entered in the editor.

To speed up the simulation 158, the inputs in step 102 are reduced or simplified by assigning the thermal functions 120 (preferably by using the primitives) in step 106 instead of the real components 112. The simulation 158 can be performed by using the primitives as proxies or arrangements reduced to the thermal function 120 or real representatives. For example, a complex component can be represented by a meandering conductor track and/or a number of primitives contiguous in one plane or stacked in multiple planes and having the same impedance and/or the same power dissipation as the real component 112. Preferably, it is irrelevant for the simulation of the thermodynamic process whether the heat flow is caused by Joule heating of the conductor track or within a junction layer of a semiconductor.

The detection 102 of the components 112, the determination 104 of the functional areas 118 and/or the assignment 106 of the thermal functions 120 can be a preliminary processing (technically also “preprocessing”) or model preparation of a product development of the combination of housing and printed circuit board. Alternatively or additionally, the determination 108 of the housing 110, preferably iteratively or multi-step modifying an initial housing, can be a post-processing or model post-processing of the product development of the combination of housing and printed circuit board.

In any exemplary embodiment, the determining 108 of the housing 110, preferably after iteratively or multi-step modifying an initial housing, can comprise post-processing, such as converting numerical results into a spatial or perspective representation of the housing 110 and/or the printed circuit board 114.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

List of Reference Numerals

| | |
|---|---|
| Method | 100 |
| Detection of an arrangement | 102 |
| Determination of functional areas | 104 |
| Assignment of thermal functions | 106 |
| Determination of a housing | 108 |
| Housing | 110 |
| Electronic components | 112 |
| Printed circuit board | 114 |
| Mounting side | 116 |
| Functional area | 118 |
| Thermal function, preferably a primitive of a thermodynamic | 120 |
| simulation | |
| Thermodynamic state or condition (TDZ), preferably temperature | 122 |
| distribution in the housing or of the housing and/or flow of a | |
| cooling medium in or out of the housing | |
| Heat sink | 124 |
| Ventilation openings | 125 |
| Device for carrying out or controlling the method | 150 |
| Design interface | 152 |
| Network, preferably Internet or radio access network | 153 |
| Database for a plurality of housings | 154 |
| Cluster of housings, preferably homeomorphic housings | 155 |
| Dataset of a housing, preferably including TDZ | 156 |
| Dataset of initial housing, preferably including TDZ | 156′ |
| Thermodynamic simulation of the TDZ | 158 |
| User device, preferably mobile device or workplace device | 160 |
| Design or construction means | 162 |

1. A method for determining a housing capable of accommodating waste heat generating electronic components on a printed circuit board, comprising:
detecting an arrangement of the electronic components on a mounting side of the printed circuit board;
determining several functional areas within the mounting side in which at least one of the electronic components is arranged according to the detected arrangement;
assigning a thermal function to each of the functional areas, each of the thermal functions comprising:
a function for generating waste heat due to a power dissipation of the at least one electronic component arranged in a respective functional area according to the detected arrangement during operation, and
a maximum temperature up to which the at least one electronic component arranged in the respective functional area is operable without damage and performance limitation; and
determining a housing which, according to the thermal functions assigned to the functional areas, is configured to dissipate the waste heat generated during operation of the electronic components while maintaining the maximum temperatures and/or determining whether a selected housing, according to the thermal functions assigned to the functional areas, is capable of dissipatingconfigured to dissipate the waste heat generated during operation of the electronic components while maintaining the maximum temperatures.

2. The method of claim 1, wherein the thermal functions are dependent on an operating state of the electronic components, and an operation of the electronic components comprises a first operating state and a second operating state different from the first operating state, and
wherein a first power dissipation in a first functional area in the first operating state is greater than in the second operating state and a second power dissipation in a second functional area is smaller in the first operating state than in the second operating state.

3. The method of claim 1, wherein the thermal function in at least one of the functional areas of the printed circuit board or in a further functional area of the housing further comprises:
a function of a heat transport according to the at least one electronic component arranged in the respective functional area and/or according to a heat sink or ventilation openings in the respective functional area or in the further functional area,
and/or
wherein one or each of the thermal functions comprises:
the function of a heat source in the respective functional are, and/or
the function of a heat sink in the respective functional are and/or
the function of a heat transport in the respective functional area.

4. The method of claim 3, wherein the thermal function of the heat transport:
comprises a heat conduction and/or a heat radiation and/or a heat convection, and/or
represents a thermal bridge or thermal insulation between the respective functional area and an environment of the housing, and/or
comprises a passive heat transport, and/or
comprises an active heat transport.

5. The method of claim 1, wherein the determining of a housing comprises a-determining of a plurality of housings each configured to dissipate the waste heat generated during the operation of the electronic components while maintaining the maximum temperatures according to thermal functions assigned to the functional areas .

6. The method of claim 5, wherein the determining of the housing comprises:
calculating or querying a temperature or temperature distribution in the plurality of housings, respectively, according to the thermal functions-420) assigned to the functional areas.

7. The method of claim 6, wherein the calculation of the temperature or temperature distribution comprises a numerical simulation of a thermodynamic process within the respective housing and/or out of the respective housing, and
wherein a combination of the respective housing with the thermal functions assigned to the functional areas of the printed circuit board determines the boundary conditions of the thermodynamic process.

8. The method of claim 7, wherein the thermodynamic process within the respective housing and/or out of the respective housing comprises a convection and/or flow of a cooling medium, prcfcrably air, within the respective housing and/or out of the respective housing.

9. The method of claim 7, wherein the determining of the housing comprises the querying a database where the following is stored for a plurality of housings:
boundary conditions; and/or
control of a cross-linking of the housing; and/or
materials of the housing; and/or
temperatures and/or temperature distributions depending on an arrangement of thermal functions within the respective housing, and
wherein the query indicates the arrangement of the thermal functions assigned to the functional areas with the printed circuit board accommodated in the respective housing.

10. The method of claim 9, wherein the temperatures and/or temperature distributions resulting from previous calculations or numerical simulations are stored in the database, and
wherein a temperature and/or temperature distribution stored in the database for a similar or the most similar arrangement of the assigned thermal functions is a starting value for the numerical simulation of the thermodynamic process.

11. The method of claim 9, wherein the querying of the database yields an initial housing,
wherein the temperature distribution stored or calculated for the initial housing at a location, does not comply with the maximum temperature, and
wherein the method further comprises:
modifying the housing at a location where the temperature distribution does not comply with the maximum temperature, and
calculating the temperature distribution in the modified initial housing according to the thermal functions assigned to the functional areas.

12. The method of claim 11, wherein determining of the housing starting from the initial housing until the maximum temperatures are met, iteratively performs the steps of modifying and calculating.

13. The method of claim 11, wherein determining the housing starting from the initial housing comprises multi-step performance of the steps of modifying and calculating in a multi-stage procedure, and
wherein in a first stage of the multi-stage procedure the housing is modified in a first area, and in a second step, starting from the modification in the first step, the housing is modified in a second area that is smaller than the first area and lies entirely within the first area.

14. The method of claim 11, wherein the modifying of the housing comprises supplementing thermal bridges between the location and an exterior of the housing and/or supplementing ventilation openings and/or
wherein the modifying of the housing comprises modifying the thermal conductivity of the housing at least at the location.

15. The method of claim 11, wherein the modifying the housing is subject to constraints, predetermined mounting points in the housing for mounting the printed circuit board, predetermined mounting points for mounting the housing on a mounting rail, boundary conditions of a manufacturing of the housing, and/or maximum external dimensions of the housing.

16. The method of claim 1, wherein the respective housing is numerically represented by a Delaunay triangulation, a hierarchical data structure, an octree mesh or a hexahedral mesh.

17. The method of claim 1, wherein each of the functional areas within the mounting side of the printed circuit board are rectangular areas and/or disjoint partial areas of the mounting side.

18. The method of claim 1, wherein at least one or each of the assigned thermal functions is numerically represented by a crossing-free conductor track section whose path length within the respective functional area is greater than the extent of the respective functional area.

19. The method of claim 18, wherein an ohmic resistance of the conductor track section, a current intensity through the conductor track section, and/or a power dissipation of the conductor track section is each equivalent to an ohmic resistance, a current intensity or a power dissipation, respectively, of the at least one electronic component arranged in the respective functional area according to the detected arrangement in operation.

20. The method of claim 1, wherein detecting the arrangement of the electronic components further comprises detecting an interconnection of the electronic components.

21. The method of claim 20, wherein the assigning of the thermal functions further comprises a numerical simulation of the electronic components detected according to the interconnection, and
wherein the numerical simulation determines the thermal function of the at least one electronic component in the respective functional area in operation.

22. The method of claim 1, wherein the determining of the package further comprises determining of clearances and/or leakage distances.

23. The method of claim 1, wherein the detecting of the arrangement of the electronic components comprises:
obtaining a camera image of the printed circuit board by a camera; and
determining electronic components and/or conductor tracks in the camera image by image recognition and determining the arrangement of the electronic components and/or the interconnection on the printed circuit board based on positions of the detected electronic components in the camera image of the printed circuit board and/or a course of the detected conductor tracks in the camera image of the printed circuit board.

24. The method of claim 1, wherein the detecting of the arrangement of the components comprises:
receiving a digital design drawing of the printed circuit board; and
reading out the arrangement of the electronic components and/or the interconnection of the electronic components from the digital design drawing of the printed circuit board.

25. The method of claim 1, further comprising:
after the determining, selecting the housing for which it was determined that it is configured to dissipate the waste heat generated during the operation of the electronic components;
prior to the determining, selecting the housing for which it is to be determined whether it is configured to dissipate the waste heat generated during operation of the electronic components; and
determining and/or providing the printed circuit board based on the selected housing.
